(19) United States
(12) Patent Application Publication
(10) Pub. No.: US 2009/0115755 A1
(43) Pub. Date: May 7, 2009

(54) VACUUM FLUORESCENT DISPLAY DRIVING CIRCUIT

(76) Inventor: Yen-Ynn CHOU, Taipei County (TW)

Correspondence Address: Muncy, Geissler, Olds & Lowe, PLLC, P.O. BOX 1364, FAIRFAX, VA, 22038-1364, US

(21) Appl. No.: 12/259,636

(22) Filed: Oct. 28, 2008

(30) Foreign Application Priority Data
Nov. 1, 2007 (TW) 096141165

(51) Int. Cl. G09G 5/00; G09G 3/22

(52) U.S. Cl. 345/205; 345/75.1

(57) ABSTRACT

A vacuum fluorescent display driving circuit is disclosed. The vacuum fluorescent display driving circuit is used for driving a vacuum fluorescent display to avoid unusual displaying caused by coupling of the vacuum fluorescent display. The vacuum fluorescent display driving circuit includes a first output pin set and a second output pin set. The first output pin set includes a plurality of first output pins and each of them includes two metal oxide semiconductor transistors, the second output pin set includes a plurality of second output pins and each of them includes a metal oxide semiconductor transistor and a resistor. No coupling effect will take place when the first output pin set and the second output pin set operate in the vacuum fluorescent display driving circuit.

This Application claims priority of Taiwan Patent Application No. 096141165, filed on Nov. 1, 2007, the entirety of which is incorporated by reference herein.

### BACKGROUND OF THE INVENTION

1. Field of the Invention

The invention relates to a vacuum fluorescent display driving circuit, and more particularly to a vacuum fluorescent display driving circuit for avoiding unusual displaying of a vacuum fluorescent display device caused by an electrical coupling effect.

2. Description of the Related Art

Generally, a driving circuit of a vacuum fluorescent display (VFD) apparatus utilizes a portion of grid output pins and segment output pins as output pins to illuminate a vacuum fluorescent display device.

Please refer to FIG. 1. FIG. 1 illustrates a conventional vacuum fluorescent display driving circuit. As shown in FIG. 1, the vacuum fluorescent display driving circuit 11 comprises several pins, a pin set 111 having 6 pins as high voltage grid output pins and a pin set 112 having 16 pins as high voltage segment output pins.

The pin set 111 and the pin set 112 are coupled to a vacuum fluorescent display (VFD) device 12. Each display unit (not shown) of the vacuum fluorescent display device 12 is coupled to a high voltage grid output pin and a high voltage segment output pin. When a control signal of the high voltage grid pin and a control signal of the high voltage segment pin both are at a high level, the vacuum fluorescent display device 12 is turned on. Otherwise, when control signals of the high voltage grid pin and the high voltage segment pin both are at a low level, the vacuum fluorescent display device 12 is turned off.

However, during practical operation of illuminating a specific display unit, some unlighted display units may simultaneously generate low light illumination, resulting in unusual displaying of the vacuum fluorescent display device. An electrical coupling effect generated by coils connected between the display units and the pins may interfere with the display units, and then the unlighted display units simultaneously generate low light illumination.

To solve the above-described problems, a simple method is provided for reducing a display illumination of the display device. The interfering light from the electrical coupling effect for the display units becomes invisible. However, the disadvantage of the method is to reduce the entire illumination of the display device, hindering clear recognition.

To solve the above-described problems, another conventional method is provided for replacing the high voltage grid output pins and the high voltage segment output pins with complementary metal oxide semiconductor (CMOS) transistors so as to prevent unusual displaying of the display unit associated with the electrical coupling effect. Nevertheless, the complementary metal oxide semiconductor transistors suffer from the disadvantage of having a large surface and layout area, wherein the driving circuit becomes too large when the high voltage grid output pins and the high voltage segment output pins are replaced by complementary metal oxide semiconductor transistors. Therefore, cost becomes a prohibitive factor and convenience is reduced.

Consequently, developing a simple driving circuit for avoiding unusual displaying of a vacuum fluorescent display device caused by the electrical coupling effect, has become a main area of interest.

### BRIEF SUMMARY OF THE INVENTION

Accordingly, it is an object of the invention to provide a vacuum fluorescent display (VFD) driving circuit for driving a vacuum fluorescent display (VFD) device to avoid unusual displaying caused by a coupling effect, wherein the vacuum fluorescent display (VFD) driving circuit comprises: a first output pin set having a plurality of first output pins, wherein each of the plurality of first pins comprises two metal oxide semiconductor (MOS) transistors; and a second output pin set having a plurality of second output pins, wherein each of the plurality of second output pins comprises a metal oxide semiconductor transistor and a resistor. The first output pin set and the second output pin set cause no coupling effect in the operation of the vacuum fluorescent display driving circuit.

In another embodiment of the invention, a vacuum fluorescent display (VFD) apparatus is provided for avoiding unusual displaying caused by a coupling effect. The vacuum fluorescent display apparatus comprises a vacuum fluorescent display device and a vacuum fluorescent display driving circuit. The vacuum fluorescent display driving circuit comprises: a first output pin set having a plurality of first output pins, wherein each of the plurality of first pins comprises two metal oxide semiconductor transistors; and a second output pin set having a plurality of second output pins, wherein each of the plurality of second output pins comprises a metal oxide semiconductor transistor and a resistor. The first output pin set and the second output pin set cause no coupling effect in the operation of the vacuum fluorescent display driving circuit.

A detailed description is given in the following with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates a conventional vacuum fluorescent display driving circuit;

FIG. 2 illustrates a circuit diagram of a vacuum fluorescent display apparatus according to a preferred embodiment of the invention;

FIG. 3(a) illustrates a circuit diagram of each first output pin from the first output pin set according to a second preferred embodiment of the invention;

FIG. 3(b) illustrates a circuit diagram of each first output pin of the first output pin set according to a third preferred embodiment of the invention; and

FIG. 4 illustrates a circuit diagram of each second output pin of the second output pin set according to a fourth preferred embodiment of the invention.

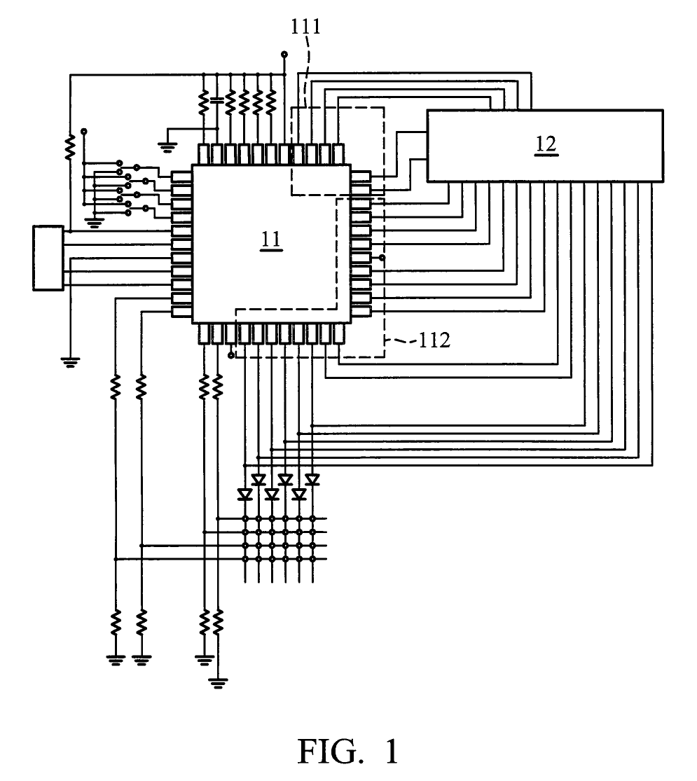

### DETAILED DESCRIPTION OF THE INVENTION

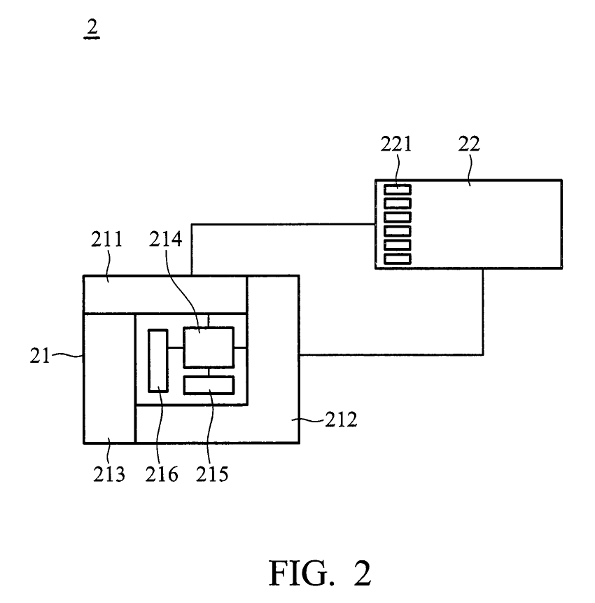

Please refer to FIG. 2. FIG. 2 illustrates a circuit diagram of a vacuum fluorescent display apparatus according to a preferred embodiment of the invention. As shown in FIG. 2, a vacuum fluorescent display apparatus 2 comprises a vacuum fluorescent display driving circuit 21 and a vacuum fluorescent display device 22. The vacuum fluorescent display driving circuit 21 comprises a first output pin set 211, a second output pin set 212, a logic input pin set 213, a driving circuit 214, a control circuit 215, and a timing circuit 216. The driving circuit 214 is coupled to the first output pin set 211 and the second output pin set 212 for generating a driving signal from the first output pin set 211 and the second output pin set 212. The control circuit 215 is coupled to the driving circuit 214 for controlling signals output from the driving circuit 214. The timing circuit 215 is coupled to the driving circuit 214 for providing a timing signal.

The first output pin set 211 comprises several first output pins. The second output pin set 212 comprises several second output pins. Each of the first output pins is coupled to the vacuum fluorescent display device 22. Likewise, each of the second output pins is coupled to the vacuum fluorescent display device 22.

The vacuum fluorescent display device 22 comprises several display units 221, wherein each of the display unit 221 is coupled to at least one first output pin and at least one second output pin and is determined to be illuminated by signals output from said first output pin and said second output pin. When signals output from said first output pin and said second output pin are at a high level, the display unit 221 is turned on. Further, when signals output from said first output pin and said second output are at a low level, the display unit 221 is turned off.

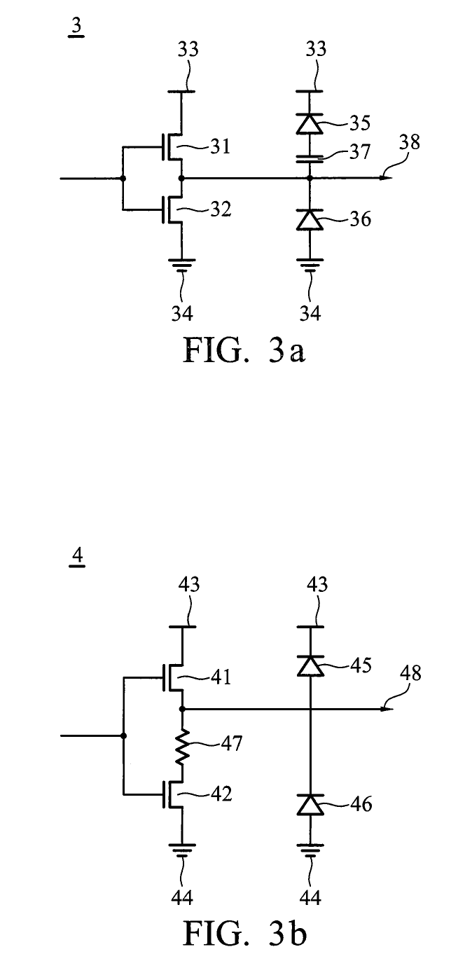

Please refer to FIG. 3(a). FIG. 3(a) illustrates a circuit diagram of each first output pin 3 from a first output pin set according to a second preferred embodiment of the invention. As shown in FIG. 3(a), a first output pin 3 comprises a first p-type MOS (PMOS) transistor 31, a first n-type MOS (NMOS) transistor 32, a voltage source 33, a ground 34, a first diode 35, a second diode 36, a first capacitor 37, and an output node 38. The source of the first PMOS transistor 31 is coupled to the voltage source 33, the drain of the first PMOS transistor 31 is coupled to the source of the first NMOS transistor 32, the drain of the first NMOS transistor 32 is coupled to the ground 34, a first node of the capacitor 37 is coupled to a second node of the first diode 35. A second node of the capacitor 37 is coupled to a first node of the second diode 36, the drain of the first PMOS transistor 31 and the source of the first NMOS transistor 32. A first node of the first diode 35 is coupled to the voltage source 33 and a second node of the second diode 36 is coupled to the ground 34.

Referring to FIG. 3(b), FIG. 3(b) illustrates a circuit diagram of each first output pin of a first output pin set 211 according to a third preferred embodiment of the invention. As shown in FIG. 3(b), the first output pin 4 comprises a second p-type MOS (PMOS) transistor 41, a second n-type MOS (NMOS) transistor 42, a voltage source 43, a low voltage source 44, a third diode 45, a fourth diode 46, a first resistor 47, and an output node 48. A source of the second PMOS transistor 41 is coupled to the voltage source 43, a drain of the second PMOS transistor 41 is coupled to a first node of the first resistor 47, a second node of the first resistor 47 is coupled to a source of the second NMOS transistor 42, a drain of the second NMOS transistor 42 is coupled to the low voltage source 44, a first node of the third diode 45 is coupled to the voltage source 43. A second node of the third diode 45 is coupled to a first node of the fourth diode 46 and a drain of the second PMOS transistor 41 and a first node of the first resistor 47. A second node of the fourth diode 46 is coupled to the low voltage 44.

The first output pin 3 and 4 are substantially similar to a complementary metal oxide semiconductor (CMOS) transistor, wherein the CMOS transistor comprises a PMOS transistor and an NMOS transistor so as to reduce a coupling effect generated by coils and to achieve a complementary arrangement.

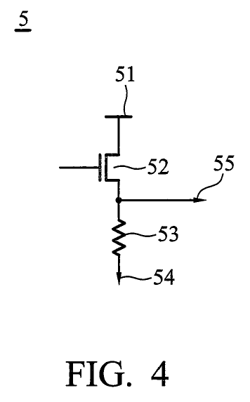

Please refer to FIG. 4. FIG. 4 illustrates a circuit diagram of each second output pin of a second output pin set 212 according to a fourth preferred embodiment of the invention. The second output pin 5 comprises a voltage source 51, a third n-type MOS (NMOS) transistor 52, a second resistor 53, a low voltage source 54, and an output node 55. A source of the third NMOS transistor 52 is coupled to the voltage source 51. A drain of the third NMOS transistor 52 is coupled to a first node of the second resistor 53. A second node of the second resistor 53 is coupled to the low voltage source 54. The output node 55 is coupled to a drain of the third NMOS transistor 52 and a first node of the second resistor 53.

The layout area of the second output pin is much smaller than that of a complementary metal oxide semiconductor (CMOS) transistor. Therefore, the configuration problem due to a large area is solved and the second output pin constructed according to the invention provides reduced cost and improved efficiency in the configuration of the system.

The display unit 211 is controlled to be turned on or off by the signals output from the first output pin set 211 and the second output pin set 212. In addition, when the first output pin and the second pin output signals, according to circuit characteristics, coils do not excite unusual displaying of the display unit 221 caused by the coupling effect.

As a result, according to the embodiments set forth above, unusual displaying of the vacuum fluorescent display device caused by the coupling effect is dramatically reduced. Furthermore, the layout area is relatively small to avoid the harmful influence which is caused by configuration of the system, thereby providing greater general commercial use.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vacuum fluorescent display driving circuit for driving a vacuum fluorescent display device to avoid unusual displaying caused by a coupling effect, wherein the vacuum fluorescent display driving circuit comprises:
a first output pin set, comprising a plurality of first output pins, wherein each of the plurality of first output pins comprises two metal oxide semiconductor (MOS) transistors; and
a second output pin set, comprising a plurality of second output pins, wherein each of the plurality of second output pins comprises a metal oxide semiconductor transistor and a resistor, and
wherein the first output pin set and the second output pin set cause no coupling effect in the operation of the vacuum fluorescent display driving circuit.

2. The vacuum fluorescent display driving circuit as claimed in claim 1, wherein each of the plurality of first output pins is a complementary metal oxide semiconductor (CMOS) transistor.

3. The vacuum fluorescent display driving circuit as claimed in claim 1, wherein each of the plurality of first output pins further comprises a voltage level shift circuit.

4. The vacuum fluorescent display driving circuit as claimed in claim 1, wherein each of the plurality of second output pins further comprises a current source and an output node interposed between the resistor and the metal oxide semiconductor transistor.

5. The vacuum fluorescent display driving circuit as claimed in claim 1, wherein the vacuum fluorescent display driving circuit further comprises a logic input pin set comprising a plurality of logic input pins.

6. The vacuum fluorescent display driving circuit as claimed in claim 1, wherein the vacuum fluorescent display driving circuit further comprises a plurality of driving circuits, a plurality of timing circuits, and a plurality of control circuits.

7. The vacuum fluorescent display driving circuit as claimed in claim 1, wherein a display unit of the vacuum fluorescent display driving device is simultaneously controlled by the first output pin set and the second output pin set, and wherein the display unit is turned on when a control signal of the first output pin set and a control signal of the second output pin set are at a high level.

8. A vacuum fluorescent display apparatus for avoiding unusual displaying caused by a coupling effect, wherein the vacuum fluorescent display apparatus comprises a vacuum fluorescent display device and a vacuum fluorescent display driving circuit, wherein the vacuum fluorescent display device comprises a plurality of display units and the vacuum fluorescent display driving circuit comprises:
a first output pin set, comprising a plurality of first output pins, wherein each of the plurality of first output pins comprises two metal oxide semiconductor (MOS) transistors; and
a second pin set, comprising a plurality of second output pins, wherein each of the plurality of second output pins comprises a metal oxide semiconductor transistor and a resistor,
wherein the first output pin set and the second output pin set cause no coupling effect in the operation of the vacuum fluorescent display driving circuit.

9. The vacuum fluorescent display apparatus as claimed in claim 8, wherein each of the plurality of first output pins is a complementary metal oxide semiconductor (CMOS) transistor.

10. The vacuum fluorescent display apparatus as claimed in claim 8, wherein each of the plurality of first output pins further comprises a level shift circuit.

11. The vacuum fluorescent display apparatus as claimed in claim 8, wherein each of the plurality of second output pins further comprises a current source and an output node interposed between the resistor and the metal oxide semiconductor transistor.

12. The vacuum fluorescent display apparatus as claimed in claim 8, wherein the vacuum fluorescent display driving circuit further comprises a logic input pin set comprising a plurality of logic input pins.

13. The vacuum fluorescent display apparatus as claimed in claim 8, wherein the vacuum fluorescent display driving circuit further comprises a plurality of driving circuits, a plurality of timing circuits, and a plurality of control circuits.

14. The vacuum fluorescent display apparatus as claimed in claim 8, wherein the plurality of display units of the vacuum fluorescent display device are simultaneously controlled by the first output pin set and the second output pin set, and wherein the plurality of display units are turned on when a control signal of the first output pin set and a control signal of the second output pin set are at a high level.
